(19) United States
(12) Patent Application Publication
(10) Pub. No.: US 2026/0321911 A1
(43) Pub. Date: Oct. 15, 2026

(54) BATTERY AND BATTERY MANUFACTURING METHOD

(71) Applicant: HONDA MOTOR CO., LTD., Tokyo (JP)

(72) Inventor: Nao Yoshinaga, Wako-shi (JP)

(21) Appl. No.: 19/467,895

(22) Filed: Feb. 3, 2026

(30) Foreign Application Priority Data
Feb. 10, 2025 (JP) 2025-020131

(51) Int. Cl. H01M 50/533; H01M 10/0585; H01M 50/536; H01M 50/538

(52) U.S. Cl. CPC H01M 50/533; H01M 10/0585; H01M 50/536; H01M 50/538

(57) ABSTRACT

A battery includes: an electrode group including a positive electrode and a negative electrode; a plurality of current collector tabs electrically connected to the positive electrode or the negative electrode of the electrode group; and a tab lead joined to the plurality of current collector tabs, wherein a joint portion between the tab lead and a current collector tab of the plurality of current collector tabs has a first joint portion having a linear form and a second joint portion having a broken line form along a longitudinal direction of the current collector tab and the tab lead.

### CROSS-REFERENCE TO RELATED APPLICATION

Priority is claimed on Japanese Patent Application No. 2025-020131, filed on Feb. 10, 2025, the contents of which are incorporated herein by reference.

### BACKGROUND

### Field of the Invention

The present invention relates to a battery and a battery manufacturing method.

### Background

In recent years, in order to ensure that more people have access to affordable, reliable, sustainable, and advanced energy, research and development relating to a secondary battery, which contributes to energy efficiency, has been conducted.

Due to the demand for secondary batteries having high energy density, it is necessary to integrate a plurality of current collector tabs into one. As a method of integrating a plurality of current collector tabs into one, for example, a method is known which uses an ultrasonic joint horn that is capable of performing ultrasonic vibration in a predetermined vibration direction and includes a base portion, a mounting portion that stands from an upper surface of the base portion, and a pressure contact portion constituted of a plurality of protrusions protruding from an upper surface of the mounting portion, wherein the plurality of protrusions constituting the pressure contact portion are aligned and formed in a pyramid shape or a truncated pyramid shape, at least part of a circumferential edge of the alignment portion of the plurality of protrusions has a zigzag shape in a plan view, the portion having the zigzag shape is formed along at least one of the vibration direction and a perpendicular direction to the vibration direction, and the upper surface of the base portion has an exposure surface on which the mounting portion is not formed (for example, refer to refer to Japanese Unexamined Patent Application, First Publication No. 2024-019281).

Further, a method is known which joins a lead and a plurality of current collector tabs sandwiched between a protection lead by ultrasonic waves so as not to cross width ends of all of the current collector tabs constituting the plurality of current collector tabs.

### SUMMARY

However, in the method of the related art as described above, although a joint area between the current collector tabs is increased, a junction resistance is reduced, and improvement of the performance of the battery cell is expected, there is a problem that input energy to a very thin current collector tab is increased, which leads to breakage of a current collector tab in contact with a pressure contact member.

An aspect of the present invention aims at providing a battery and a battery manufacturing method in which a sufficient joint is obtained without breakage of a joint portion between a current collector tab and a tab lead. The aspect of the present invention contributes to stable battery performance, improvement in quality control over manufacturing steps, and energy efficiency.

A first aspect of the present invention is a battery including: an electrode group including a positive electrode and a negative electrode; a plurality of current collector tabs electrically connected to the positive electrode or the negative electrode of the electrode group; and a tab lead joined to the plurality of current collector tabs, wherein a joint portion between the tab lead and a current collector tab of the plurality of current collector tabs has a first joint portion having a linear form and a second joint portion having a broken line form along a longitudinal direction of the current collector tab and the tab lead.

In the battery according to the first aspect of the present invention, since the joint portion between the current collector tab and the tab lead has the first joint portion having a linear form and the second joint portion having a broken line form along the longitudinal direction of the current collector tab and the tab lead, a sufficient joint can be obtained without breaking the joint portion between the current collector tab and the tab lead.

A second aspect is the battery according to the first aspect described above, wherein the joint portion may have the first joint portion and the second joint portion that is arranged along each of two edges in a longitudinal direction of the first joint portion.

In the battery according to the second aspect of the present invention, since the joint portion has the first joint portion and the second joint portion that is arranged along each of the two edges in the longitudinal direction of the first joint portion, a sufficient joint can be obtained without breaking the joint portion between the current collector tab and the tab lead.

A third aspect is the battery according to the second aspect described above which may have two first joint portions each of which is the first joint portion.

Since the battery according to the third aspect of the present invention has the two first joint portions, a sufficient joint can be obtained without breaking the joint portion between the current collector tab and the tab lead.

A fourth aspect is a battery manufacturing method of a battery including: an electrode group including a positive electrode and a negative electrode; a plurality of current collector tabs electrically connected to the positive electrode or the negative electrode of the electrode group; and a tab lead joined to the plurality of current collector tabs, the battery manufacturing method including: performing ultrasonic joint of the current collector tabs and the tab lead by sandwiching a lamination of the tab lead and a current collector tab of the plurality of current collector tabs by an ultrasonic joint tool from both sides, applying a load to the lamination, and applying ultrasonic vibration to the lamination, wherein the ultrasonic joint tool has a first press portion having a linear form and a second press portion having a concave-convex form along a longitudinal direction of the current collector tab and the tab lead on a surface in contact with the current collector tab or the tab lead.

In the battery manufacturing method according to the fourth aspect of the present invention, since the ultrasonic joint tool has the first press portion having a linear form and the second press portion having a concave-convex form along the longitudinal direction of the current collector tab and the tab lead on the surface in contact with the current collector tab and the tab lead, a sufficient joint can be obtained without breaking the joint portion between the current collector tab and the tab lead.

A fifth aspect is the battery manufacturing method according to the fourth aspect described above, wherein the ultrasonic joint tool may have the first press portion and the second press portion that is arranged along each of two edges in a longitudinal direction of the first press portion.

In the battery manufacturing method according to the fifth aspect of the present invention, since the ultrasonic joint tool has the first press portion and the second press portion that is arranged along each of the two edges in the longitudinal direction of the first press portion, a sufficient joint can be obtained without breaking the joint portion between the current collector tab and the tab lead.

A sixth aspect is the battery manufacturing method according to the fifth aspect described above, wherein two first press portions each of which is the first press portion may be provided.

In the battery manufacturing method according to the sixth aspect of the present invention, since the two first press portions are provided, a sufficient joint can be obtained without breaking the joint portion between the current collector tab and the tab lead.

According to the aspect of the present invention, it is possible to provide a battery and a battery manufacturing method in which a sufficient joint is obtained without breakage of a joint portion between a current collector tab and a tab lead.

### BRIEF DESCRIPTION OF THE DRAWINGS

FIG. 1 is a plan view showing a joint portion between a current collector tab and a tab lead of a battery according to an embodiment of the present invention.

FIG. 2 is a plan view showing a joint portion between a current collector tab and a tab lead of a battery according to the embodiment of the present invention.

FIG. 3 is a schematic view showing a battery manufacturing method according to the embodiment of the present invention.

FIG. 4 is a plan view showing a press member used in the battery manufacturing method according to the embodiment of the present invention.

FIG. 5 is a front view showing a first press portion of the press member used in the battery manufacturing method according to the embodiment of the present invention.

FIG. 6 is a front view showing a second press portion of the press member used in the battery manufacturing method according to the embodiment of the present invention.

FIG. 7 is a plan view showing a press member used in the battery manufacturing

method according to the embodiment of the present invention.

### DESCRIPTION OF EMBODIMENTS

Hereinafter, a battery and a battery manufacturing method according to an embodiment of the present invention will be described with reference to the drawings.

### Battery

A battery according to an embodiment of the present invention includes: an electrode group including a positive electrode and a negative electrode; a plurality of current collector tabs electrically connected to the positive electrode or the negative electrode of the electrode group; and a tab lead joined to the plurality of current collector tabs, wherein a joint portion between the tab lead and a current collector tab of the plurality of current collector tabs has a first joint portion having a linear form and a second joint portion having a broken line form along a longitudinal direction of the current collector tab and the tab lead.

The electrode group has, for example, a positive electrode in a sheet form, a negative electrode in a sheet form, and a separator arranged between the positive electrode and the negative electrode. The positive electrode and the negative electrode are spirally wound or laminated via the separator.

The positive electrode has, for example, a current collector made of an aluminum foil or an aluminum alloy foil and a positive electrode active material layer including a positive electrode active material formed on one surface of the current collector. Examples of the positive electrode active material include oxides, sulfides, polymers, and the like that are capable of absorbing and releasing lithium. Examples of the positive electrode active material include a lithium manganese complex oxide, a lithium nickel complex oxide, a lithium cobalt complex oxide, lithium iron phosphate, and the like that can provide a high positive electrode potential.

The negative electrode has, for example, a current collector made of a copper foil and a negative electrode active material layer including a negative electrode active material formed on one surface of the current collector. Examples of the negative electrode active material include metal oxides, metal sulfides, metal nitrides, alloys, and the like that are capable of absorbing and releasing lithium. Examples of the negative electrode active material include titanium oxide, lithium titanium oxide, tungsten oxide, amorphous tin oxide, tin silicon oxide, silicon oxide, and the like.

Examples of the separator include a microporous membrane, a woven fabric, a nonwoven fabric, a laminate of the same material or different materials among these materials, and the like. Examples of a material forming the separator include polyethylene, polypropylene, ethylene-propylene copolymer, ethylene-butene copolymer, and the like.

A non-aqueous electrolyte is immersed in the electrode group. The non-aqueous electrolyte is prepared by dissolving an electrolyte (for example, a lithium salt) in a non-aqueous solvent. Examples of the non-aqueous solvent include ethylene carbonate (EC), propylene carbonate (PC), butylene carbonate (BC), dimethyl carbonate (DMC), diethyl carbonate (DEC), ethyl methyl carbonate (EMC), γ-butyrolactone (γ-BL), sulfolane, acetonitrile, 1, 2-dimethoxyethane, 1, 3-dimethoxypropane, dimethyl ether, tetrahydrofuran (THF), 2-methyltetrahydrofuran, and the like. One of non-aqueous solvents may be used alone, or two or more of the non-aqueous solvents may be mixed and used. Examples of the electrolyte include lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and the like. One of electrolytes may be used alone, or two or more of the electrolytes may be mixed and used.

Positive electrode current collector tabs are electrically connected to a plurality of portions of the positive electrode, and each of the positive electrode current collector tabs is led out from the electrode group. Negative electrode current collector tabs are electrically connected to a plurality of portions of the negative electrode, and each of the negative electrode current collector tabs is led out from the electrode group.

For example, a positive electrode current collector tab that partially extends from a current collector of the positive electrode can be used, but the positive electrode current collector tab may be a separate body from the positive electrode. Further, for example, a negative electrode current collector tab that partially extends from a current collector of the negative electrode can be used, but the negative electrode current collector tab may be a separate body from the negative electrode. In the case of the separate body, a current collector tab made of a conductive material is electrically connected to the current collector by ultrasonic joint or the like.

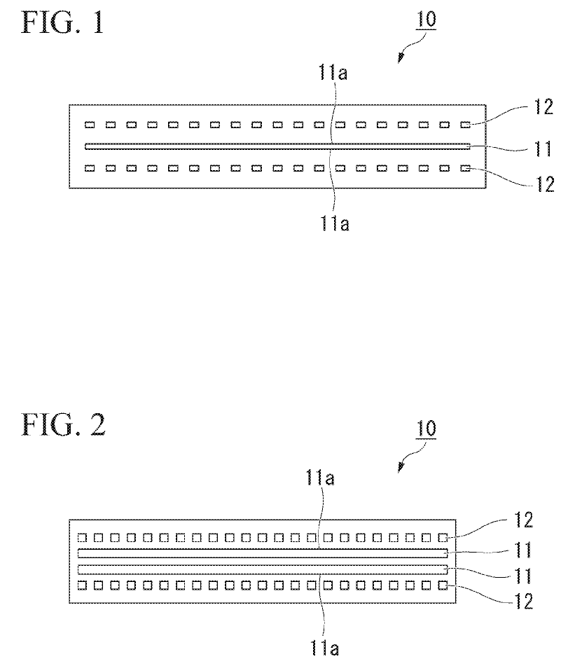

In a battery of the present embodiment, as shown in FIG. 1, a joint portion 10 between a current collector tab and a tab lead has a first joint portion 11 having a linear form and a second joint portion 12 having a broken line form along a longitudinal direction of the current collector tab and the tab lead. The joint portion 10 can preferably have the first joint portion 11 and second joint portions 12, 12 each of which is arranged along each of two edges 11a, 11a in a longitudinal direction of the first joint portion 11. Thereby, a sufficient joint can be obtained without breaking the joint portion 10 between the current collector tab and the tab lead.

In the battery of the present embodiment, as shown in FIG. 2, the configuration shown in FIG. 1 can preferably have two first joint portions 11. That is, the joint portion 10 can preferably have two first joint portions 11, 11 arranged in parallel with each other, a second joint portion 12 arranged along an edge 11a in the longitudinal direction of one first joint portion 11, and a second joint portion 12 arranged along an edge 11a in the longitudinal direction of another first joint portion 11. Thereby, a sufficient joint can be obtained without breaking the joint portion 10 between the current collector tab and the tab lead.

According to the battery of the present embodiment, since the joint portion 10 between the current collector tab and the tab lead has the first joint portion 11 having a linear form and the second joint portion 12 having a broken line form along the longitudinal direction of the current collector tab and the tab lead, a sufficient joint can be obtained without breaking the joint portion 10 between the current collector tab and the tab lead.

### Battery manufacturing method

A battery manufacturing method according to an embodiment of the present invention is a manufacturing method of a battery including: an electrode group including a positive electrode and a negative electrode; a plurality of current collector tabs electrically connected to the positive electrode or the negative electrode of the electrode group; and a tab lead joined to the plurality of current collector tabs, the battery manufacturing method having a step (hereinafter, referred to as a “joint step”) of performing ultrasonic joint of the current collector tabs and the tab lead by sandwiching a lamination of a current collector tab and the tab lead by an ultrasonic joint tool from both sides, applying a load to the lamination, and applying ultrasonic vibration to the lamination, wherein the ultrasonic joint tool has a first press portion having a linear form and a second press portion having a concave-convex form along a longitudinal direction of the current collector tab and the tab lead on a surface in contact with the current collector tab or the tab lead.

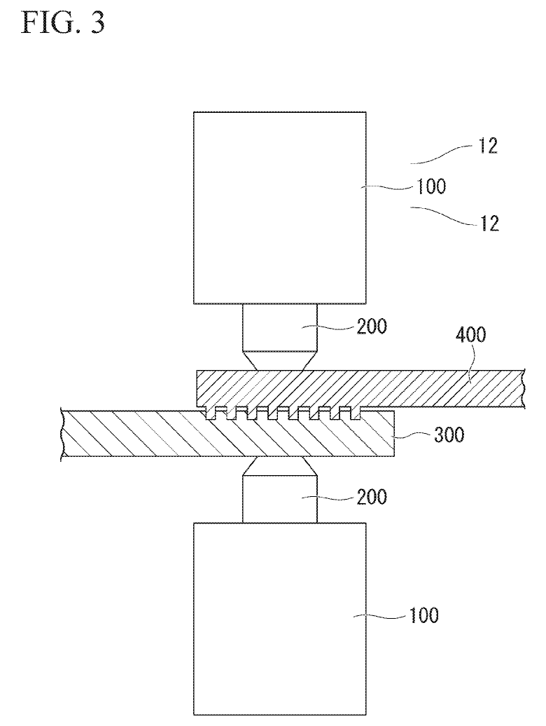

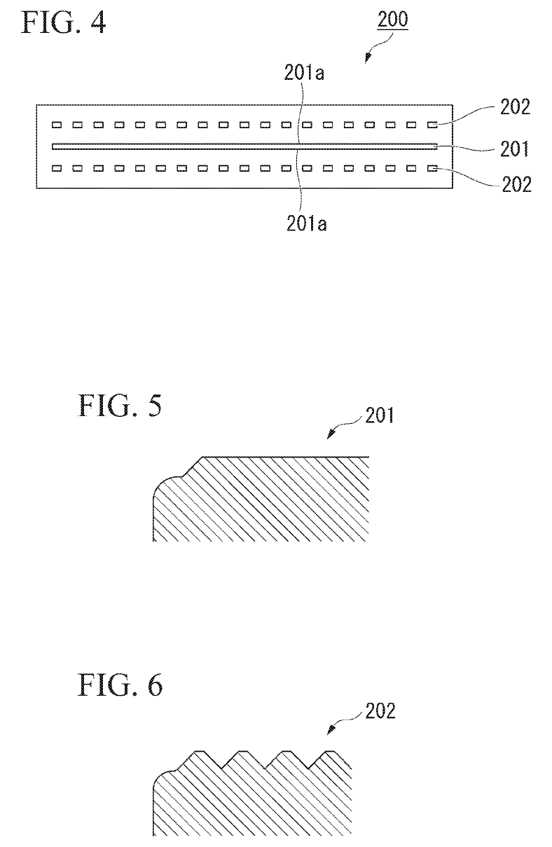

In the joint step, as shown in FIG. 3, a current is applied to an ultrasonic joint tool 100 while sandwiching a lamination of a current collector tab 300 and a tab lead 400 from both sides by the ultrasonic joint tool 100 and applying a pressure to the lamination, and the current collector tab 300 and the tab lead 400 are joined together. More specifically, as shown in FIG. 4, a press member 200 is provided on the ultrasonic joint tool 100 on a surface in contact with the current collector tab 300 or the tab lead 400. A first press portion 201 having a linear form as shown in FIGS. 4 and 5 and a second press portion 202 having a concave-convex form as shown in FIGS. 4 and 6 are provided on the surface in contact with the current collector tab 300 or the tab lead 400 in the press member 200 along the longitudinal direction of the current collector tab 300 and the tab lead 400. The press member 200 can preferably have the first press portion 201 and second press portions 202, 202 each of which is arranged along each of two edges 201a, 201a in a longitudinal direction of the first press portion 201.

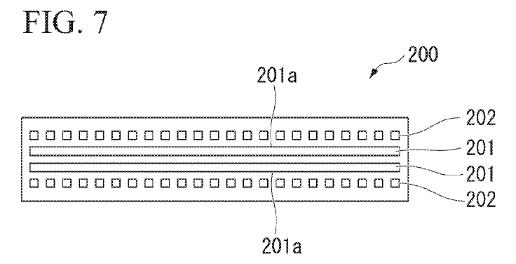

In the battery of the present embodiment, as shown in FIG. 7, the configuration shown in FIG. 4 can preferably have two first press portions 201. That is, the press member 200 can preferably have two first press portions 201, 201 arranged in parallel with each other, a second press portion 202 arranged along an edge 201a in the longitudinal direction of one first press portion 201, and a second press portion 202 arranged along an edge 201a in the longitudinal direction of another first press portion 201. Thereby, a sufficient joint can be obtained without breaking the joint portion between the current collector tab 300 and the tab lead 400.

According to the battery manufacturing method of the present embodiment, since the press member 200 of the ultrasonic joint tool 100 has the first press portion 201 having a linear form and the second press portion 202 having a concave-convex form along the longitudinal direction of the current collector tab 300 and the tab lead 400 on the surface in contact with the current collector tab 300 or the tab lead 400, a sufficient joint can be obtained without breaking the joint portion between the current collector tab 300 and the tab lead 400.

Although the embodiment of the present invention has been described in detail, the present invention is not limited to the above embodiment, and various modifications and changes can be made within the scope of the gist of present invention described in the claims.

What is claimed is:

1. A battery comprising:
an electrode group including a positive electrode and a negative electrode;
a plurality of current collector tabs electrically connected to the positive electrode or the negative electrode of the electrode group; and
a tab lead joined to the plurality of current collector tabs,
wherein a joint portion between the tab lead and a current collector tab of the plurality of current collector tabs has a first joint portion having a linear form and a second joint portion having a broken line form along a longitudinal direction of the current collector tab and the tab lead.

2. The battery according to claim 1,
wherein the joint portion has the first joint portion and the second joint portion that is arranged along each of two edges in a longitudinal direction of the first joint portion.

3. The battery according to claim 2, comprising:
two first joint portions each of which is the first joint portion.

4. A battery manufacturing method that is a manufacturing method of a battery which comprises:
an electrode group including a positive electrode and a negative electrode;
a plurality of current collector tabs electrically connected to the positive electrode or the negative electrode of the electrode group; and
a tab lead joined to the plurality of current collector tabs, the battery manufacturing method comprising:
performing ultrasonic joint of the current collector tabs and the tab lead by sandwiching a lamination of the tab lead and a current collector tab of the plurality of current collector tabs by an ultrasonic joint tool from both sides, applying a load to the lamination, and applying ultrasonic vibration to the lamination,
wherein the ultrasonic joint tool has a first press portion having a linear form and a second press portion having a concave-convex form along a longitudinal direction of the current collector tab and the tab lead on a surface in contact with the current collector tab or the tab lead.

5. The battery manufacturing method according to claim 4,
wherein the ultrasonic joint tool has the first press portion and the second press portion that is arranged along each of two edges in a longitudinal direction of the first press portion.

6. The battery manufacturing method according to claim 5,
wherein two first press portions each of which is the first press portion are provided.
